(19) United States
(12) Patent Application Publication
(10) Pub. No.: US 2005/0018970 A1
(43) Pub. Date: Jan. 27, 2005

(54) Method for coupling planar lightwave circuit and optical fiber

(76) Inventors: Shiao-Min Tseng, Hsinchu (TW); Nan-Kuang Chen, Taipei Hsien (TW)

Correspondence Address: BIRCH STEWART KOLASCH & BIRCH, PO BOX 747, FALLS CHURCH, VA, 22040-0747, US

(21) Appl. No.: 10/865,898

(22) Filed: Jun. 14, 2004

(30) Foreign Application Priority Data
Jun. 13, 2003 (TW) 092116080

(51) Int. Cl. G02B 6/30

(52) U.S. Cl. 385/49; 385/14

(57) ABSTRACT

A method for coupling a planar lightwave circuit and an optical fiber. A side-polished optical fiber is formed with a polished surface at its side. When the side-polished optical fiber and the planar lightwave circuit are coupled, the polished surface of the side-polished optical fiber is adhered to the planar lightwave circuit. According to an evanescent field interaction, signals transmitted in the planar lightwave circuit can be coupled to the side-polished optical fiber. Additionally, signals transmitted in the side-polished optical fiber can be coupled to the planar lightwave circuit.

### BACKGROUND OF THE INVENTION

1. Field of the Invention

The invention relates to a method and device for coupling an optical waveguide, and in particular, to a method and device for coupling a planar lightwave circuit and an optical fiber.

2. Description of the Related Art

Application of semiconductor mass-production technology in the development of passive and active devices for optical communication is a recent trend. Additionally, planar lightwave circuits technology and metropolitan optical fiber communication network have recently been developed, as detailed in “PHASAR-based WDM-devices: principles, design and applications” in “IEEE Journal of Selected Topics in Quantum Electronics, vol. 2, pp. 236-250” by M. K. Swit and C. van Dam in 1996; and “Silica-based planar lightwave circuits: passive and thermally active devices” in “IEEE Journal of Selected Topics in Quantum Electronics, vol. 6, pp. 38-45” by T. Miya in 2000. Thus, it is important to develop technology for conveniently coupling planar lightwave circuits and other devices.

Generally, there are two methods for coupling optical fibers and planar lightwave circuits. One method is to directly couple the optical fiber 1 and one end of the planar lightwave circuit 2, as shown in FIG. 1A and FIG. 1B. When a planar optical waveguide comprises a plurality of optical outputs, optical fibers 1 can be disposed in grooves 3 to couple to the optical outputs of optical waveguides respectively. The distance between the adjacent grooves corresponds to the distance between the adjacent optical outputs of the optical waveguide. Another method is to place a micro-optical device, such as a collimator 4 to adjust beams, between the optical fiber 1 and the planar lightwave circuit 2, as shown in FIG. 2.

The conventional methods, however, are time-consuming and cumbersome. In view of this, the inventor has developed a technology for coupling a planar lightwave circuit and an optical fiber employing “V-shaped grooves”. Specifically, after calculation, the optical fiber is disposed in the V-shaped groove in a manner such that its cladding layer is partially exposed by the groove to be polished to form a side-polished surface.

U.S. Pat. No. 5,781,675 and U.S. Pat. No. 5,809,188, filed by the inventor, provide optical fibers adapted in this invention, characterized by different interaction lengths and precise sizes from the side-polishing close to the evanescent field of the optical fiber. The coupling method of this invention thus provides improved applicability and effect.

### SUMMARY OF THE INVENTION

To attain the coupling method of this invention, the inventor overcomes the disadvantages and difficulty of the conventional coupling technology except that the inventor has owned the above patents. The invention can couple the planar lightwave circuit and the optical fiber under a better condition. In the invention, the optical fiber comprises a polished surface. Thus, when the optical fiber and the planar lightwave circuit are coupled, the polished surface of the optical fiber adheres to the planar lightwave circuit. According to an evanescent field interaction, signals transmitted in the planar lightwave circuit can be coupled to the optical fiber and vice versa.

Accordingly, the invention provides a device coupling to a planar lightwave circuit, comprising a polished substrate, a side-polished optical fiber, and a sliding member. The polished substrate comprises a V-shaped groove and a first aligning groove. The side-polished optical fiber is disposed in the V-shaped groove. The sliding member is disposed in the first aligning groove. The planar lightwave circuit comprises a second aligning groove. When the side-polished optical fiber is adhered to the planar lightwave circuit, they are aligned by the first aligning groove and the second aligning groove. Thus, the planar lightwave circuit and the side-polished optical fiber are coupled based on the evanescent field interaction. Additionally, the side-polished optical fiber can be conveniently adhered to the planar lightwave circuit by the aligning grooves and the sliding member.

In a preferred embodiment, the polished substrate is a silicon wafer. The V-shaped groove and the first aligning groove are formed on a (100)-oriented surface of the silicon wafer.

Furthermore, liquid, glue, or polymer material is disposed between the polished surface and the planar lightwave circuit to enhance coupling ratio therebetween.

In another embodiment, the device further comprises glue for fixing the side-polished optical fiber in the V-shaped groove.

Moreover, the polished substrate and the planar lightwave circuit are fixed by glue, mechanical clipping, or laser fusing.

In another embodiment, the device further comprises a package covering the polished substrate, the side-polished optical fiber, and the sliding member to relieve strain on the side-polished optical fiber.

It is noted that the contact area and the coupling ratio between the polished surface of the side-polished optical fiber and the planar lightwave circuit can be adjusted by the aligning grooves and the sliding member. Thus, the labor and time required for adjusting the coupling ratio can be reduced.

Additionally, since the polished surface of the side-polished optical fiber is provided by the silicon substrate, the plurality of optical fibers can be easily manufactured. Moreover, since the polished surface of the side-polished optical fiber can be adjusted by the silicon substrate, different coupling ratios can be attained.

In the invention, a method for coupling a planar lightwave circuit is provided, comprising the following steps. A polished substrate comprising a V-shaped groove and a first aligning groove is provided. A single-mode optical fiber is fixed in the V-shaped groove by glue. A cladding layer of single-mode optical fiber is polished to form a side-polished optical fiber with a polished surface until the core of the single-mode optical fiber is close to the polished surface. A second aligning groove is formed on the planar lightwave circuit. The polished surface is adhered to the planar lightwave circuit by aligning the first aligning groove with the second aligning groove so that the planar lightwave circuit and the side-polished optical fiber are coupled. A sliding member is placed between the first aligning groove and the second aligning groove so that the polished substrate and the planar lightwave circuit slide along the sliding member.

### BRIEF DESCRIPTION OF THE DRAWINGS

The present invention can be more fully understood by reading the subsequent detailed description and examples with references made to the accompanying drawings, wherein:

FIGS. 1A and 1B are schematic views of a conventional method for coupling optical fibers and a planar lightwave circuit;

FIG. 2 is a schematic view of another conventional method for coupling optical fibers and a planar lightwave circuit;

FIG. 3 is a schematic view of a linear mask progressively wider toward each end;

FIG. 4A is a longitudinal sectional view of a silicon substrate;

FIG. 4B is a cross section of a silicon substrate;

FIG. 5 is a longitudinal sectional view showing an optical fiber fixed in a V-shaped groove;

FIG. 6 is a cross section showing a polished optical fiber fixed in a V-shaped groove;

FIGS. 7A and 7B are schematic views showing a coupling device of the present invention;

FIG. 8 is a schematic view showing side-polished optical fibers adhered to a planar lightwave circuit;

FIG. 9 is a cross section along a line A-A in FIG. 8; and

FIG. 10 is a schematic view showing a package for protecting the side-polished optical fibers and the planar lightwave circuit.

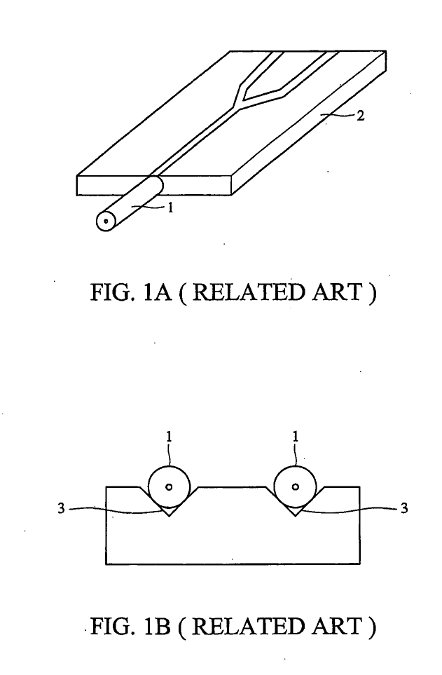

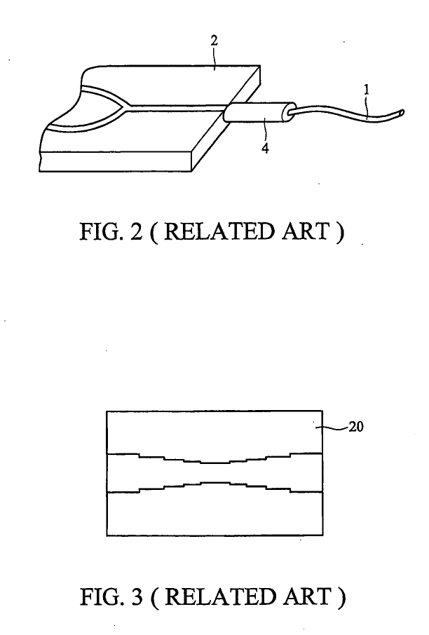

### DETAILED DESCRIPTION OF THE INVENTION

In this embodiment, a substrate of a polished optical fiber is made of material with oriented etching, such as a semiconductor substrate. For example, a silicon wafer may be used.

FIG. 3 is a schematic view of a linear mask progressively wider toward each end. By a method for manufacturing an integrated circuit, a curved type graph progressively wider toward each end is formed on a silicon wafer by the mask 20 as shown in FIG. 3. The silicon wafer is preferably (100)-oriented, but is not limited thereto.

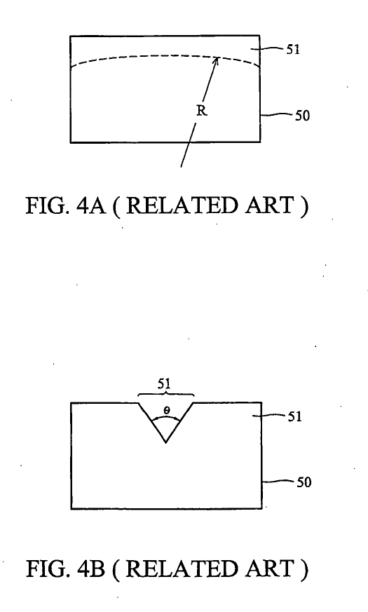

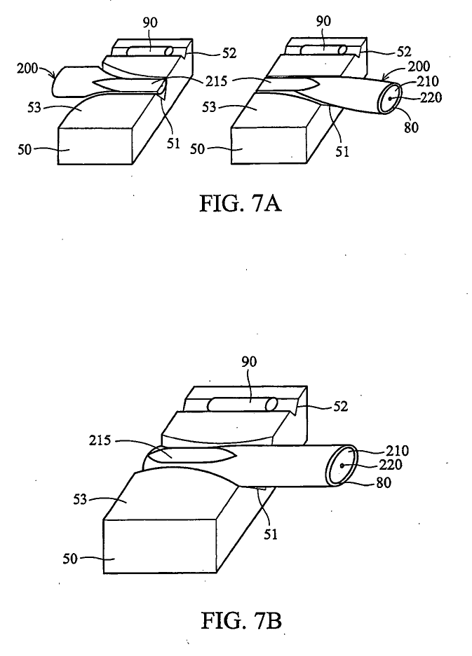

FIG. 4A is a longitudinal sectional view of a silicon substrate, and FIG. 4B is a cross section of a silicon substrate. A V-shaped groove 51 with a radius R is formed using the anisotropically etching characteristics of the silicon substrate 50. In FIG. 4A, a V-shaped groove with a long radius R is precisely formed by etching. For example, R may be 1000 cm, providing the side-polished optical fiber with a long and effective interaction-length. In FIG. 4B, the V-shaped groove 51 is provided with an angle θ (=70.53°). In addition, a plurality of V-shaped grooves 51 can be formed by the method for manufacturing the integrated circuit at the same time. Referring to FIG. 7A, a first aligning groove 52 is formed on a (100)-oriented surface of the silicon substrate 50 by the method for manufacturing an integrated circuit. The first aligning groove 52 is substantially parallel with the V-shaped groove 51.

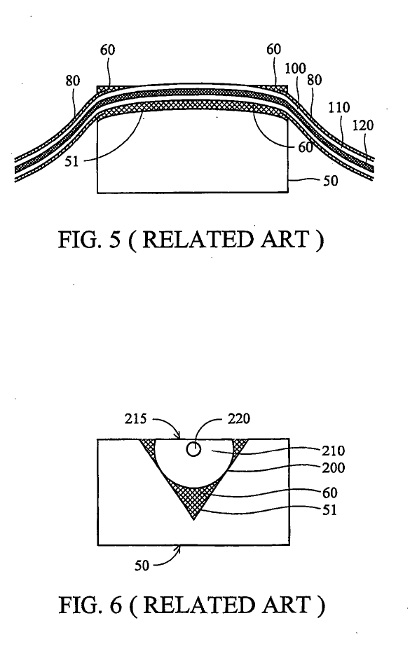

FIG. 5 is a longitudinal sectional view showing an optical fiber fixed in a V-shaped groove. First, glue 60 is added at both ends of the groove 51. The glue 60 moves toward the center of the groove 51 by capillary action. The glue 60 is liquid with a refractive index similar to that of a cladding layer 110 of the optical fiber 100. Then, an exposed portion of an optical fiber 100 is fixed in the groove 51 with the glue 60 as shown in FIG. 5. The size of the interaction area of the optical fiber after polishing can be adjusted by changing the radius R of the V-shaped groove 51.

In addition, the optical fiber 100 may first be disposed in the groove 51. Then, the glue 60 is added at both ends of the groove 51. The glue 60 rapidly moves toward a gap between the optical fiber 100 and the groove 51 by capillary action as shown in FIG. 5.

Moreover, referring to FIG. 5, a jacket layer 80, located at both ends of the V-shaped groove 51, of the optical fiber 100, is not removed, thus protecting the optical fiber 100 from breaking during polishing.

FIG. 6 is a cross section showing the polished optical fiber fixed in the V-shaped groove. Furthermore, a cladding layer 110 of the optical fiber 100 protruding form a surface of the silicon substrate is polished until the polished surface of the optical fiber 100 is flush with the (100)-oriented surface of the silicon substrate 50. As shown in FIG. 6, a core 220 of a side-polished optical fiber 200 is extremely close to the polished surface 215 of the side-polished optical fiber 200.

FIGS. 7A and 7B are schematic views showing a coupling device as disclosed in the invention. As shown in FIG. 7A and FIG. 7B, the coupling device comprises a silicon substrate 50, a side-polished optical fiber 200, and a sliding member 90. The silicon substrate 50 comprises a V-shaped groove 51 and a first aligning groove 52 at its (100)-oriented surface 53. The side-polished optical fiber 200 is disposed in the V-shaped groove 51. The sliding member 90 is disposed in the first aligning groove 52. Referring to FIG. 7A, the center of the polished surface 215 of the side-polished optical fiber 200 is cut by a cutting device, such as a mechanical cutter, laser, or water-jet, to form two portions. The two portions have the same area of the polished surface 215. Furthermore, referring to FIG. 7B, one end of the silicon substrate and the side-polished optical fiber 200 without the polished surface are cut by a cutting device, such as a mechanical cutter, laser, or water-jet, to form the device 300.

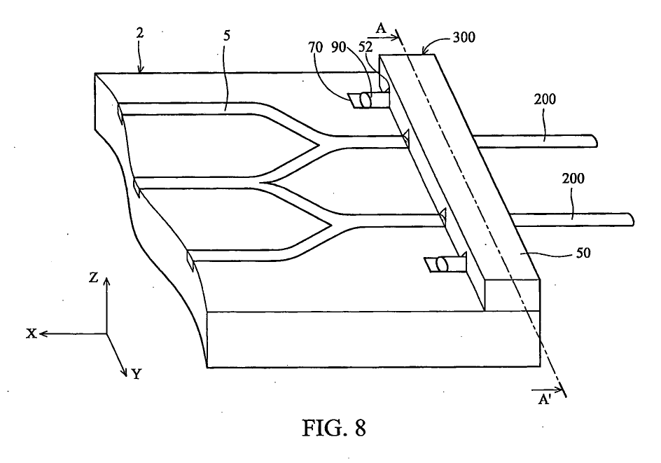

FIG. 8 is a schematic view showing the optical fibers adhered to the planar lightwave circuit. Specifically, the polished surface of the side-polished optical fiber 200 in the device 300 is adhered to the planar lightwave circuit 2, such as a planar optical waveguide. According to evanescent field interaction, signals transmitted in the planar lightwave circuit 2 are coupled to the side-polished optical fiber 200, or signals transmitted in the side-polished optical fiber 200 are coupled to the planar lightwave circuit 2.

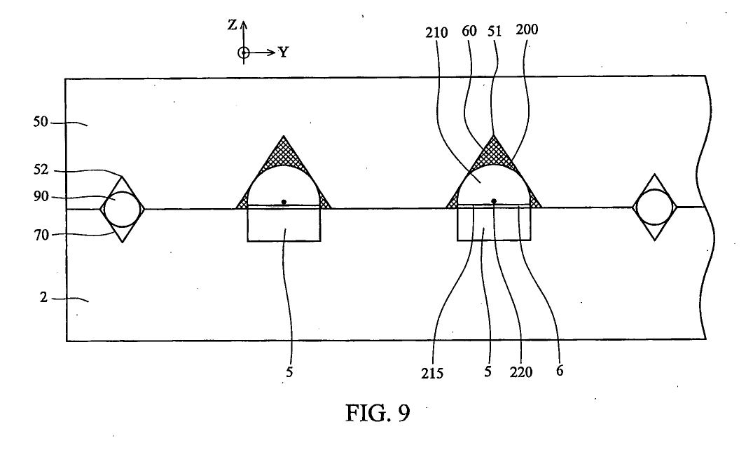

FIG. 9 is a cross section along a line A-A in FIG. 8, showing the side-polished optical fibers 200 adhered to the planar lightwave circuit 2. As shown in FIG. 9, a second aligning groove 70 is formed on a surface of the planar lightwave circuit 2, corresponding to the first aligning groove 52 at the (100)-oriented surface 53 of the silicon substrate 50. The second aligning groove 70 may be formed by semiconductor processes or mechanical cutting. When the first aligning groove 52 and the second aligning groove 70 are aligned, the polished surface 215 of the side-polished optical fiber 200 and the planar optical waveguide 5 are also aligned. Additionally, in the planar lightwave circuit 2, the distance between adjacent optical outputs coupled to the optical fibers is equal to the distance between the adjacent V-shaped grooves 51 of the silicon substrate 50. The distance between the adjacent V-shaped grooves 51 of the silicon substrate 50 can be precisely formed by the method for manufacturing the integrated circuit. Furthermore, the sliding member 90 is disposed between the first aligning groove 52 and the second aligning groove 70. Referring to FIG. 8 and FIG. 9, the device 300 can be moved relative to the planar lightwave circuit 2 in an X direction by the sliding member 90. Thus, the contact area between the polished surface of the side-polished optical fibers 200 and the planar lightwave circuit 2 can be adjusted by moving in an axial direction of the sliding member 90. Moreover, since the device 300 can be moved relative to the planar lightwave circuit 2 by the sliding member 90, the coupling ratio of the signals between the device 300 and the planar lightwave circuit 2 can be adjusted. Furthermore, referring to FIG. 9, liquid 6 with a refractive index similar to that of the cladding layer 110 of the optical fiber 100, glue, or polymer material may be added between the device 300 and the planar lightwave circuit 2 to enhance the coupling ratio therebetween.

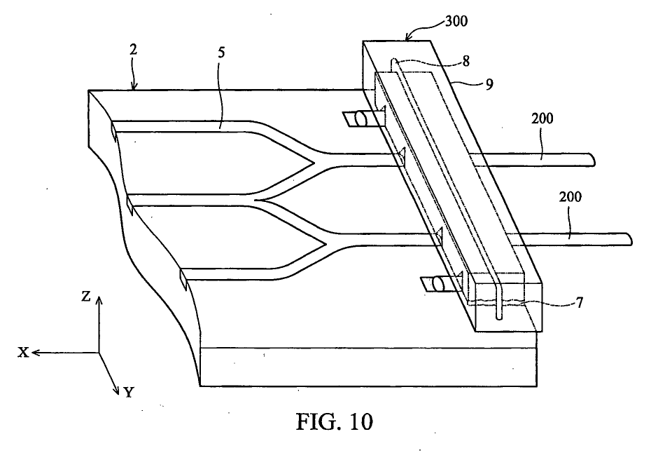

FIG. 10 is a schematic view showing a package for protecting the device 300 and the planar lightwave circuit 2. When the coupling ratio between the device 300 and the planar lightwave circuit 2 reaches a predetermined value, the device 300 and the planar lightwave circuit 2 are fixed by glue 7, mechanical clipping 8, or laser fusing. Moreover, the package 9 can cover the device 300 and the planar lightwave circuit 2 to relieve strain on the side-polished optical fiber 200.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A device coupling to a planar lightwave circuit, comprising:
a polished substrate comprising a V-shaped groove with a predetermined radius and a first aligning groove parallel with the V-shaped groove;
a side-polished optical fiber, disposed in the V-shaped groove, comprising a core and a cladding layer covering the core, wherein the cladding layer comprises a polished surface located in the V-shaped groove; and
a sliding member disposed in the first aligning groove;
wherein the planar lightwave circuit comprises a second aligning groove, the planar lightwave circuit and the side-polished optical fiber are coupled when the polished surface is adhered to the planar lightwave circuit by aligning the first aligning groove with the second aligning groove.

2. The device as claimed in claim 1, wherein the polished substrate is a silicon wafer, and the V-shaped groove and the first aligning groove are formed on a (100)-oriented surface of the silicon wafer.

3. The device as claimed in claim 1, wherein liquid, glue, or polymer material is disposed between the polished surface and the planar lightwave circuit.

4. The device as claimed in claim 1, further comprising glue for fixing the side-polished optical fiber in the V-shaped groove.

5. The device as claimed in claim 1, wherein the polished substrate and the planar lightwave circuit are fixed by glue, mechanical clipping, or laser fusing.

6. The device as claimed in claim 1, further comprising a package covering the polished substrate, the side-polished optical fiber, and the sliding member to relieve strain on the side-polished optical fiber.

7. A method for coupling a planar lightwave circuit and an optical fiber, comprising:
providing a polished substrate comprising a first aligning groove and a V-shaped groove with a predetermined radius;
fixing a single-mold optical fiber in the V-shaped groove by glue;
polishing a cladding layer of the single-mode optical fiber to form a side-polished optical fiber with a polished surface until a core of the single-mode optical fiber is close to the polished surface;
forming a second aligning groove on the planar lightwave circuit, and adhering the polished surface to the planar lightwave circuit by aligning the first aligning groove with the second aligning groove so that the planar lightwave circuit and the side-polished optical fiber are coupled; and
placing a sliding member between the first aligning groove and the second aligning groove so that the polished substrate and the planar lightwave circuit slide along the sliding member.

8. The method as claimed in claim 7, further comprising:
adding the glue at both ends of the V-shaped groove, the glue is then moved toward a center of the V-shaped groove by capillary action, evenly distributing the glue in the V-shaped groove; and
placing the optical fiber in the V-shaped groove.

9. The method as claimed in claim 7, further comprising:
placing the optical fiber in the V-shaped groove; and
adding the glue at both ends of the V-shaped groove, the glue is then moved toward a center of the V-shaped groove by capillary action, evenly distributing the glue in a gap between the V-shaped groove and the optical fiber.

10. The method as claimed in claim 7, wherein the V-shaped groove is formed by etching.

11. The method as claimed in claim 7, wherein the polished substrate and the planar lightwave circuit are fixed by glue, mechanical clipping, or laser fusing.

12. The method as claimed in claim 7, wherein the polished substrate is a silicon wafer, and the V-shaped groove is formed on a (100)-oriented surface of the silicon wafer.
